(19) United States
(12) Patent Application Publication
(10) Pub. No.: US 2011/0313805 A1
(43) Pub. Date: Dec. 22, 2011

(54) CUSTOMIZABLE USER INTERFACE INCLUDING CONTACT AND BUSINESS MANAGEMENT FEATURES

(75) Inventors: Christian Heydemann, Kirkland, WA (US); Ron Mondri, Bellevue, WA (US); Vineet Gupta, Kirkland, WA (US)

(73) Assignee: Microsoft Corporation, Redmond, WA (US)

(21) Appl. No.: 12/819,169

(22) Filed: Jun. 18, 2010

(51) Int. Cl. G06F 3/048; G06Q 30/00; G06Q 10/00

(52) U.S. Cl. 705/7.14; 715/777; 715/765; 705/7.26; 705/7.39

(57) ABSTRACT

Embodiments provide aspects of a workspace interface that includes a number of customizable business role workspaces, but are not so limited. In an embodiment, a computer-implemented method provides a number of role-specific workspaces as part of an integrated business development application, each role-specific workspace including role-specific ribbon tools, gadgets, and/or tabs tailored to address particular aspects of a business or business role. In one embodiment, a number of customizable role-specific workspaces are combined with personal information management features as part of providing an integrated business management solution. Other embodiments are included and available.

### BACKGROUND

Software applications are typically designed with the goal of providing some defined application functionally to assist an end-user with some task or tasks. For example, an email and scheduling application can include functionality to send and receive emails, track tasks, make appointments, etc. A sales management application can be used to track product sales, supplier data, purchase orders, etc. A project management application can be used to track project tasks. Unfortunately, a handful of separate applications are ordinarily required in order to attain some application functionality or feature.

Moreover, a design choice as to how an application functions and looks can often be one of the limiting factors affecting extensibility and usability. For example, an email and scheduling application does not include functionality to work seamlessly with emails while managing multiple business functions. Additionally, any allowable interface personalization or customization operations may be stringently limited for both strategic and design considerations. Unfortunately, an application offering a unified control center to manage many different aspects of a business is unavailable.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide aspects of a workspace interface that includes a number of customizable business role workspaces, but are not so limited. In an embodiment, a computer-implemented method provides a number of role-specific workspaces as part of an integrated business development application, each role-specific workspace including role-specific ribbon tools, gadgets, and/or tabs tailored to address particular aspects of a business or business role. In one embodiment, a number of customizable role-specific workspaces are combined with personal information management features as part of providing an integrated business management solution. Other embodiments are included and available.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing system.

FIG. 2 depicts aspects of an exemplary workspace interface.

FIG. 3 depicts aspects of an exemplary workspace interface.

FIG. 4 depicts aspects of an exemplary sales-related workspace.

FIG. 5 depicts an exemplary preview pane customization interface.

FIG. 6 depicts an exemplary gadget selection interface.

FIG. 7 depicts aspects of an exemplary marketing-related workspace.

FIG. 8 depicts aspects of an exemplary project-related workspace.

FIG. 9 depicts an exemplary interface that can be used to modify a tab.

FIG. 10 depicts the exemplary interface of FIG. 9 once the user selects an Item type interface.

FIG. 11 depicts an exemplary interface that can be used to group fields.

FIG. 12 depicts an exemplary interface that can be used to add a column to a record list display area.

FIG. 13 is a flow diagram illustrating an exemplary process of providing role-specific workspace features.

FIG. 14 is a block diagram illustrating an exemplary computing environment for implementation of various embodiments described herein.

### DETAILED DESCRIPTION

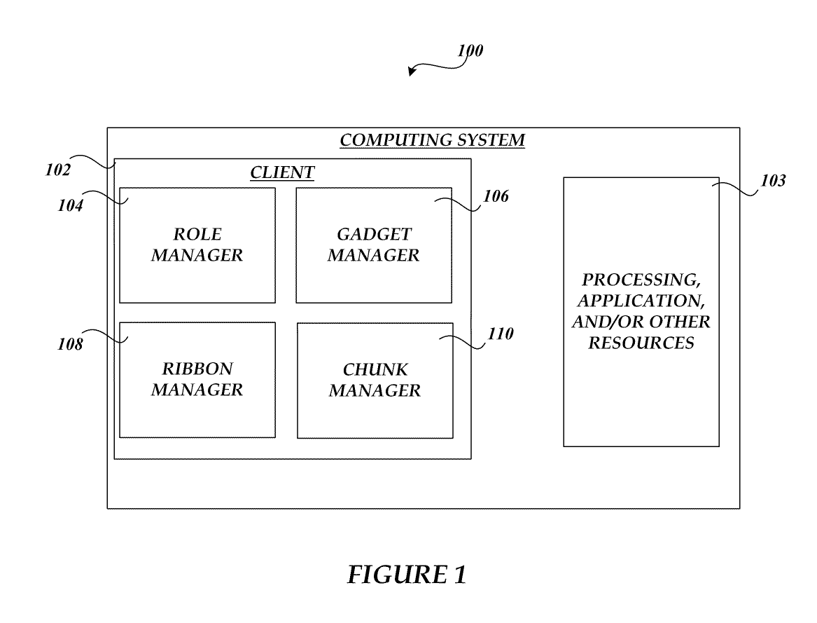

FIG. 1 is a block diagram of an exemplary computing system 100. As shown, the system 100 includes a client 102 and other components, including display, processing, memory, application, and other resources, shown collectively as 103. While only a single computing system 100 is shown, it will be appreciated that other computing components and/or systems can be included and communicatively coupled with system 100. In one embodiment, a database system is coupled to the system 100 and used to store and/or track information associated with a number of role-specific workspaces. In one embodiment, a peer group computing architecture can use features of the client 102 to share business-related and other information.

As discussed below, components of the client 102 can operate to provide role-specific workspaces that can be used to manage critical business and other functions, but the components are not so limited. For example, the client 102 can provide an interactive user interface having a rich set of extensible features that can be used to assist a small business owner to manage various business roles including sales, marketing, financial, legal, and other business affairs within an integrated customizable user interface.

The client 102 of an embodiment can be used to provide an interactive workspace that includes the use and/or display of configurable gadgets that track key performance indicators (KPIs). For example, a user can selectively display gadgets that are important to performing some aspect of a defined business function or role. Exemplary gadgets can include graphical charts and other informative visualizations that display information relevant to a particular business role. The client 102 can also be used to create customized lists of business entities including customizing a preview pane according to some viewable configuration. In an embodiment, the client features are integrated with electronic mail (email), voicemail, time management (e.g., calendar, scheduler, etc.), and/or personal contact functional components. In other embodiments, the client 102 can be configured as a stand-alone or add-in component for the system 100.

As shown in FIG. 1, the client 102 of an embodiment includes a number of functional components that can include the use of hardware and/or software to provide various role-specific workspaces. The client 102 of one embodiment includes a role manager 104, a gadget manager 106, a ribbon manager 108, and/or a chunk manager 110 that operate to provide a rich-set of interactive features within the context of a personal information management system that includes functional email and/or time management applications, but is not so limited. It will be appreciated that functions of the various components can be combined and/or further divided.

The role manager 104 can be used to manage new and/or existing roles and/or functions of a particular end-user, including managing new and existing folder and/or tab components that populate a workspace interface. For example, the role manager 104 can operate to configure each tab as a base object including default filters, default fields, default preview pane chunks, default “group by” parameters, etc. The role manager 104 of one embodiment can be used to customize user roles according to some business context. For example, a business owner can use any number of business-related roles as part of monitoring any number of business contacts, metrics, and/or other tasks affecting or potentially affecting a successful business operation.

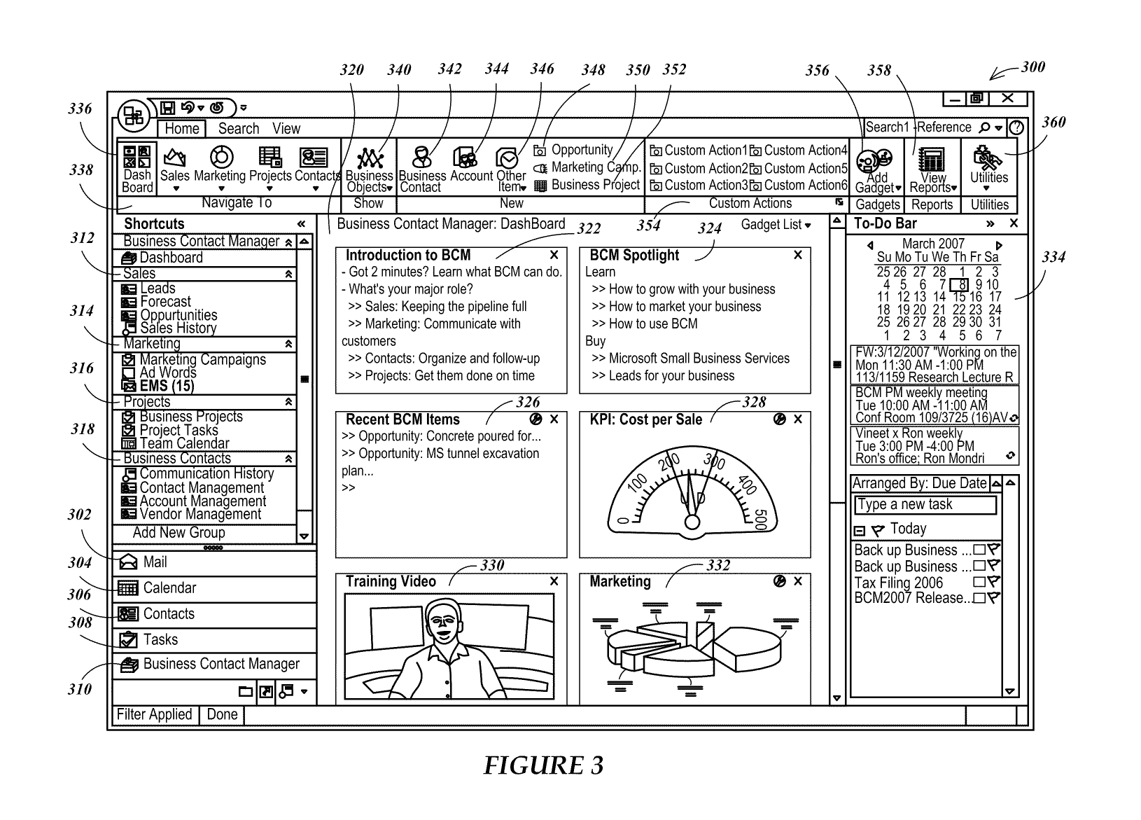

New roles and supporting workspace interface components can be generated using the role manager 104 (e.g., new folder for a new role, new tabs for a new role, etc.). As one example, a business owner can use a client 102 to provide a role workspace interface (see examples of FIGS. 3, 4, 7, and 8) that can be used to manage: a sales role including any associated sales contacts and metrics; a marketing role including any associated marketing contacts and metrics; a project role including any associated project contacts and metrics; and/or a business contact management role overseeing all contacts and metrics. In one embodiment, the client 102 can include a number of default roles, gadgets, and/or tabs for populating in each workspace.

The gadget manager 106 can be used to manage gadget displays within a role workspace interface. For example, the gadget manager 106 can provide different gadget options for a sales role as compared to a marketing role, legal role, or some other role. In one embodiment, the gadget manager 106 provides a number of default gadgets that correspond to particular business role scenarios. For example, the gadget manager 106 can include default sales gadget types, default marketing gadget types, default project management gadget types, and/or default general business gadgets.

The ribbon manager 108 can be used to manage role-relevant interactive tools that can be displayed for user selection and use. For example, the ribbon manager 108 can populate different tools and toolsets for a sales role as compared to a marketing role, legal role, or some other role. The chunk manager 110 can be used to design and build read-only and active “chunks” of information to display in the workspace interface. The chunk manager 110 can be used as part of defining, selecting, and/or arranging workspace chunks. For example, read-only and editable chunks can be defined to populate a workspace display portion for business contacts, accounts, opportunities, communication history, marketing campaigns, project tasks, etc. As another example, the chunk manager 110 can use preview pane chunk information provided by the role manager 104 as part of populating a workspace preview or reading pane.

In one embodiment, the client 102 is configured to provide business contact management features including customer relationship management features that can be used to manage different aspects of different types of businesses. The client 102 can be configured as a stand alone component or, in alternative implementations, as a plug-in (or add-on) component providing features and functionality accessed from within a separate application (e.g., a personal information management application). Business management features of the client 102 enable users to store and track information including: Accounts (e.g., companies or organizations that are customers), Business Contacts, Opportunities (e.g., potential revenue and/or expansion), Marketing Campaigns (e.g., email, phone, printed campaigns, etc.), Projects, and/or Project tasks, but are not so limited. Types of data tracked by the client 102 of an embodiment can be classified by entity-type. In one embodiment, each instance of an entity-type represents an item. For example, a Business Contact or an Account can be classified as an entity-type, and a Business Contact named John Doe can be classified as an item. Each entity-type can include a set of attributes or properties, wherein items can include different values for certain attributes. While certain components and functionalities are described in conjunction with FIG. 1, other embodiments are available.

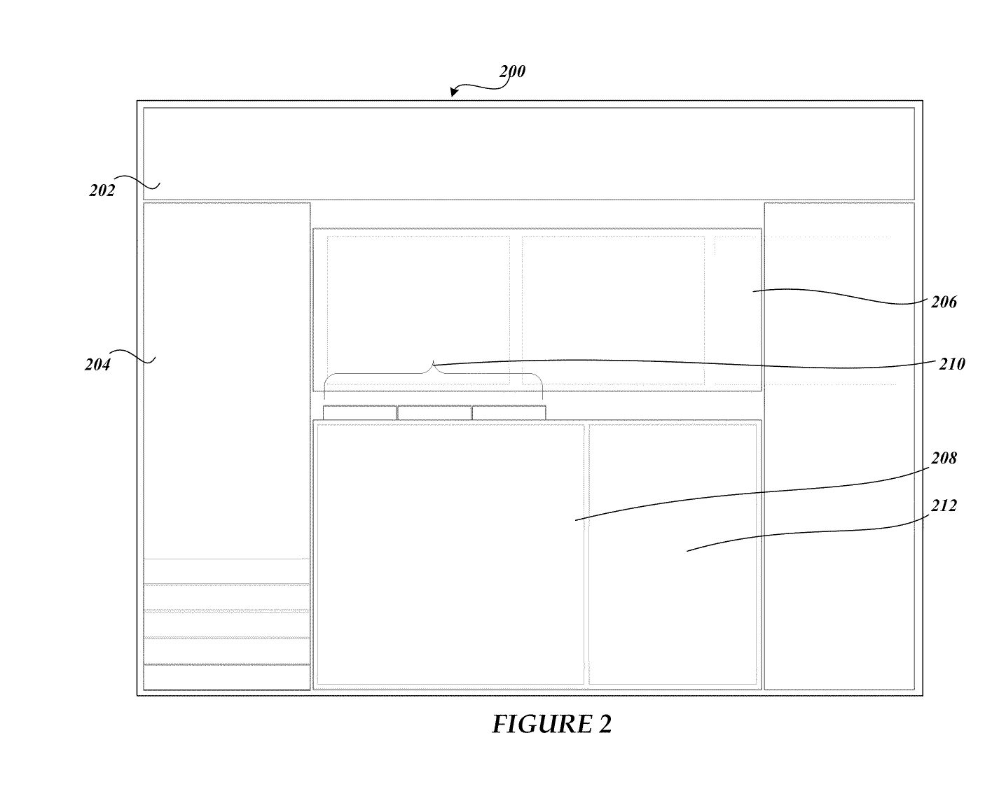

FIG. 2 depicts aspects of an exemplary workspace interface 200. The workspace interface 200 can be customized and personalized according to an end-user implementation. The workspace interface 200 can be used to manage a number of role-specific business functions using various role-specific workspaces as part of attaining certain business goals. The workspace interface 200 can be used to manage business contacts and maximize effectiveness within a number of different business areas. Aspects of a personalized workspace can be stored in memory (e.g., local and/or remote) for subsequent use. For example, aspects of a personalized workspace interface 200, such as select business metrics and contacts for example, can be retrieved from memory and incorporated with features of a personal time management application, including email features, scheduling/time management features, etc.

In one embodiment, the workspace interface 200 can be configured to include business contact management features, sales role features, marketing role features, project management role features, and other features integrated within a centralized business contact manager application. The workspace interface 200 enables a user to see a complete view of customers, projects, sales processes, and/or marketing activities. For example, the workspace interface 200 can include a number of selectable role-specific workspaces, each workspace including graphical charts, lists of records, controls, and other features that can be strategically used to accomplish various business tasks associated with some ongoing business concern. Exemplary workspaces include sales, marketing, project management, contact management, and other business-driven workspaces. Each workspace provides another piece of information reflecting a multi-faceted business interface, including the tools to succeed in each business role.

As shown in FIG. 2, the workspace interface 200 of an embodiment is organized into a number of workspace sections including a ribbon section 202, a folder section 204, a gadget section 206, a record list section 208 including a number of tab interfaces (shown collectively as 210), and a preview section 212, but is not so limited. In an embodiment, each tab can be used to display a list of records in the record list section 208 and/or a preview of a record item in the preview section 212, but is not so limited.

A filter can be applied to each tab to show exactly the data a user needs to accomplish some task. For example, a user could choose a filter that selects only bicycles shops in Seattle along with a filter that identifies current business contacts for bike parts. The workspace interface 200 can be personalized further including custom formatting of business records (font, color, etc.), and/or defining viewable fields to show and/or filter within the record list section 208 and/or preview section 212. The preview section 212 of an embodiment can be configured to display detailed information of a selected record and is customizable to show just the information that a user desires to see in contrast to a predefined static preview pane. It will be appreciated that each workspace section can include subsections and/or sub-components, as discussed further below.

The ribbon section 202 can be populated with a number of default and/or customized ribbon tools. In one embodiment, the ribbon section 202 can be dynamically populated with ribbon tools that are most relevant to a particular workspace. The ribbon section 202 of one embodiment includes a Home control, a Sales control, a Marketing control, a Projects control, and a Business Contacts control. For example, a ribbon section 202 for a sales workspace can be populated with sales-related ribbon tools that can be used to support a user's sales role, a ribbon section 202 for a marketing workspace can be populated with marketing-related ribbon tools that can be used to support a user's marketing role, a ribbon section 202 for a project management workspace can be populated with project-related ribbon tools that can be used to support a user's project management role function, and so forth.

The folder section 204 can be populated with folders corresponding to various roles supported by the workspace interface 200. For example, the folder section 204 can include a sales folder that, when selected, configures the workspace interface 200 according to a sales role, including populating various sections with information and tools directed to achieving certain sales goals. As another example, the folder section 204 can include a marketing folder that, when selected, configures the workspace interface 200 according to a marketing role, including populating various sections with information and tools directed to achieving certain marketing goals. As yet another example, the folder section 204 can include a project folder that, when selected, configures the workspace interface 200 according to a project management role, including populating various sections with information and tools directed to achieving certain project oriented goals.

The gadget section 206 can be used to display a number of useful and/or role-specific gadgets based in part on a selection in the folder section 204. In one embodiment, the gadget section 206 can be dynamically populated with gadgets that are most relevant to a particular workspace. Different types of gadgets can be populated in and/or removed from the gadget section 206 according to a user preference and/or business role for example. Gadgets can be used to display key metrics that a business user can use to monitor aspects of a particular business or business role. For example, a number of default gadgets can be provided and selectively populated in the gadget section 206. Exemplary gadgets can be populated in the gadget section 206 and used to enhance a user's understanding and awareness of ongoing business sales, projects, contact relationships, and/or marketing activities.

In one embodiment, a gadget component can use gadget metrics to track: how frequently gadgets are reordered within the gadget section 206 (e.g., by dragging, adding, deleting); which gadgets are displayed in the gadget section 206 for a given role during some usage time or period; how frequently gadgets are removed from the gadget section 206, including tracking removed gadgets; how frequently new gadgets are added to the gadget section 206, and the types of gadgets added; and/or how frequently each link in a gadget is used.

FIG. 3 depicts aspects of an exemplary workspace interface 300. For example, the workspace interface 300 can be displayed using a computing display and used by an end-user to manage different aspects of an ongoing business or venture. The workspace interface 300 also includes a number of personal information management features including a mail component 302, a calendar component 304, a contacts component 306, and a tasks component 308. The business contact manager 310 is currently selected or active and provides a number of interactive features that can be used to manage aspects of a user's business or some business role or function.

As shown in FIG. 3, an overview (e.g., the Dashboard) of application features are providing in the workspace interface 300 when the business contact manager 310 is selected as part of providing a business contact management (BCM) environment. A section includes a Sales component 312, a Marketing component 314, a Projects component 316, and a Business Contacts component 318. The workspace display area 320 for this example includes an introduction to BCM information area 322, a BCM spotlight information area 324, a recent BCM items information area 326, an exemplary sales-related gadget 328 illustrating a sales-related KPI, a training video 330, and an exemplary marketing-related gadget 332 illustrating a marketing-related KPI. The workspace interface 300 also includes a to-do area 334 that includes a calendar, reminders, and other types of time-management information.

A ribbon 336 includes a number of ribbon tools that can be used in part to interact with and personalize aspects of the workspace interface 300. As described below, different types of gadgets and/or ribbon tools can be dynamically displayed and/or modified based in part on a current role-specific workspace in focus. As shown, ribbon 336 includes a display section 338 that includes sales, marketing, projects, and contacts interfaces that correspond with components 312-318. The exemplary ribbon 336 includes a business objects interface 340, a business contact interface 342, an account interface 344, personal information management interface 346, an opportunity interface 348, a marketing campaign interface 350, a business project interface 352, a custom action section 354 that contains a number of custom actions, an add gadget interface 356, a view reports interface 358, and a utilities interface 360.

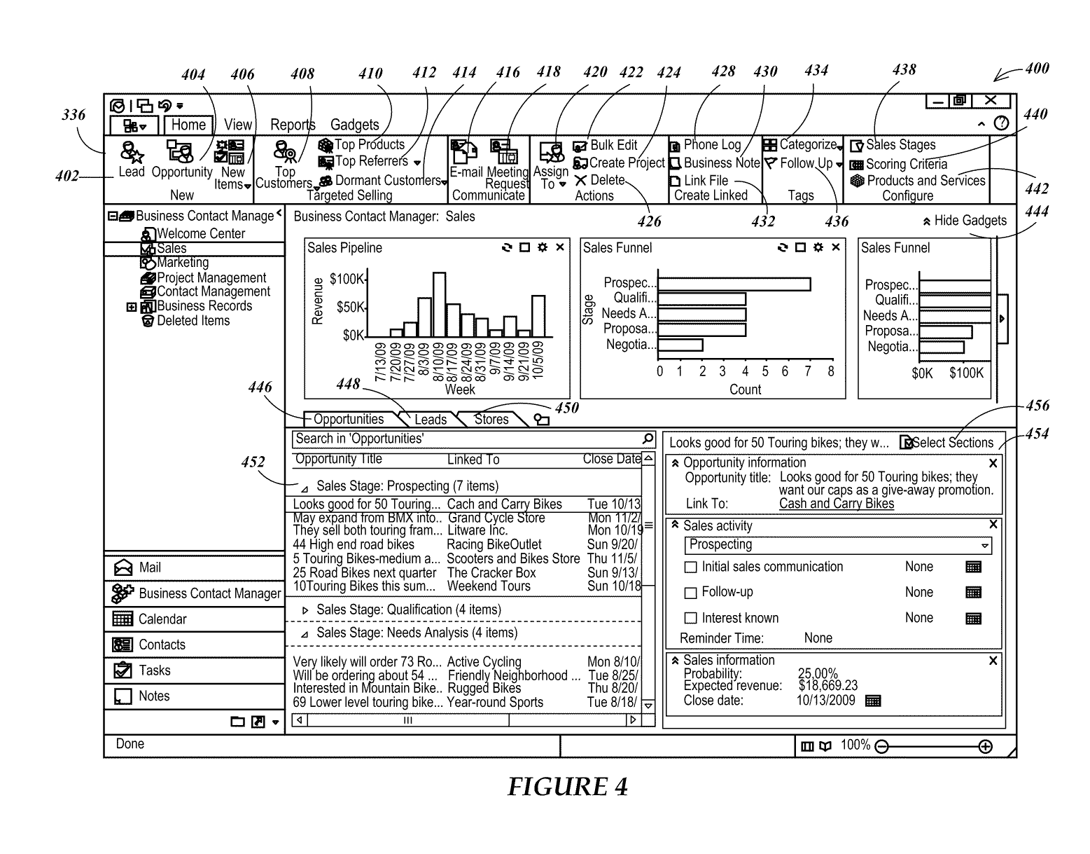

FIG. 4 depicts aspects of an exemplary sales-related workspace 400. For example, the sales-related workspace 400 can be provided upon selecting the Sales component 312 or ribbon option. As shown, the ribbon 336 has been dynamically updated to include sales-related ribbon tools that include a new section including a lead interface 402, an opportunity interface 404, and a new items interface 406; a targeted selling section that includes a top customers interface 408, a top products interface 410, a top referrers interface 412, and a dormant customers interface 414; a communicate section that includes an email interface 416, and a meeting request interface 418; an actions section that includes an assign to interface 420, a bulk edit interface 422, a create project interface 424, and a delete interface 426; a create linked section that includes a phone log interface 428, a business note interface 430, and a link file interface 432; a tags section that includes a categorize interface 434, and a follow-up interface 436; and, a configure section that includes a sales stage interface 438, scoring criteria interface 440, and a products and services interface 442. Each of the various ribbon interfaces can be used to as part of interacting with the sales-related workspace 400.

As shown in FIG. 4, the exemplary sales-related workspace 400 includes a gadget display section 444 that includes a number of exemplary sales-related gadgets for the sales business role. Different types of gadgets can be added to and/or removed from the gadget display section 444 according to a user or design preference. For example, a user can right click in the gadget display section 444 and bring up gadget menu to add, remove, and/or configure some sales-related gadget or gadgets. Exemplary sales-related gadgets include: Dormant Customers; Sales Pipeline; Sales Funnel; Top Customers; Top Products; and/or Top Referrers.

The exemplary sales-related workspace 400 also includes a number of selectable and/or modifiable tabs including an opportunities tab 446, a leads tab 448, and a stores tab 450. A user can modify the tabs, including changing tab names, adding tabs, and removing tabs. Other exemplary tabs include a forecast tab, product tab, a services tab, and/or a “add new” tab that can be used to create custom tabs. As an example of creating a customized tab, a user can right click in the tab section to “create a new tab” and include text identifying opportunities assigned to the user or some contact that are located in a particular area that have a current sales forecast of greater than some monetary goal amount (e.g., $5,000.00). The new tab can be used as a focal point for a day's activities. Next week, the user may choose to delete the customized tab as being no longer relevant.

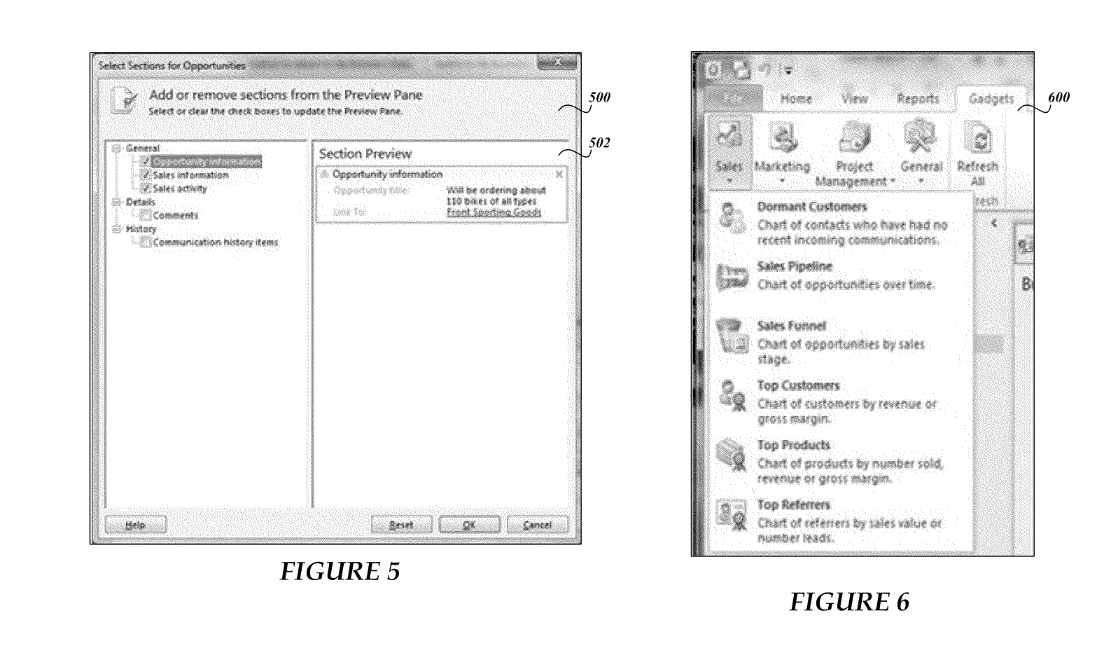

As shown, the opportunities tab 446 is currently selected which operates to display record list items within a record list display area 452. The record list display area 452 can be used to contain all attributes and/or values that are valid for the relevant role-specific workspace. As shown, the record list display area 452 is displaying various sales stages including a prospecting stage, a qualification stage, and needs analysis stage all conveniently displayed within the confines of the sales-related workspace 400. A preview pane 454 is also included within the exemplary sales-related workspace 400 to display aspects of a selected record item (the first record in this example). As shown, the user can use the “Select Sections” interface 456 to display select information to be displayed in the preview pane 454 (see FIG. 5 for example). The user can add or remove item information to be displayed in the preview pane 454. The user can also configure portions of the preview pane 454 according to a user preference.

FIG. 5 depicts an exemplary preview pane customization interface 500 that includes a number of selectable options for display within preview pane 454. As shown by example, a user can opt to include opportunity information, sales information, sales activity, comments, and/or communication history items within the preview pane 454. The preview pane customization interface 500 includes a section preview portion 502 that provides a preview of opted-for information to be displayed within preview pane 454. It will be appreciated that any number of selectable options can be included in preview pane customization interface 500 based in part on information of displayed record list items.

FIG. 6 depicts an exemplary gadget selection interface 600 that can be used to populate the gadget display section 444 with different types of sales-related gadgets. Exemplary sales-related gadgets include charts, graphs, and/or other quantified performance indicators that can be populated and referred to in the sales-related workspace 400. As shown, exemplary gadgets include a dormant customer chart, a sales pipeline chart, a sales funnel chart, a top customers chart, a top products chart, and a top referrers chart.

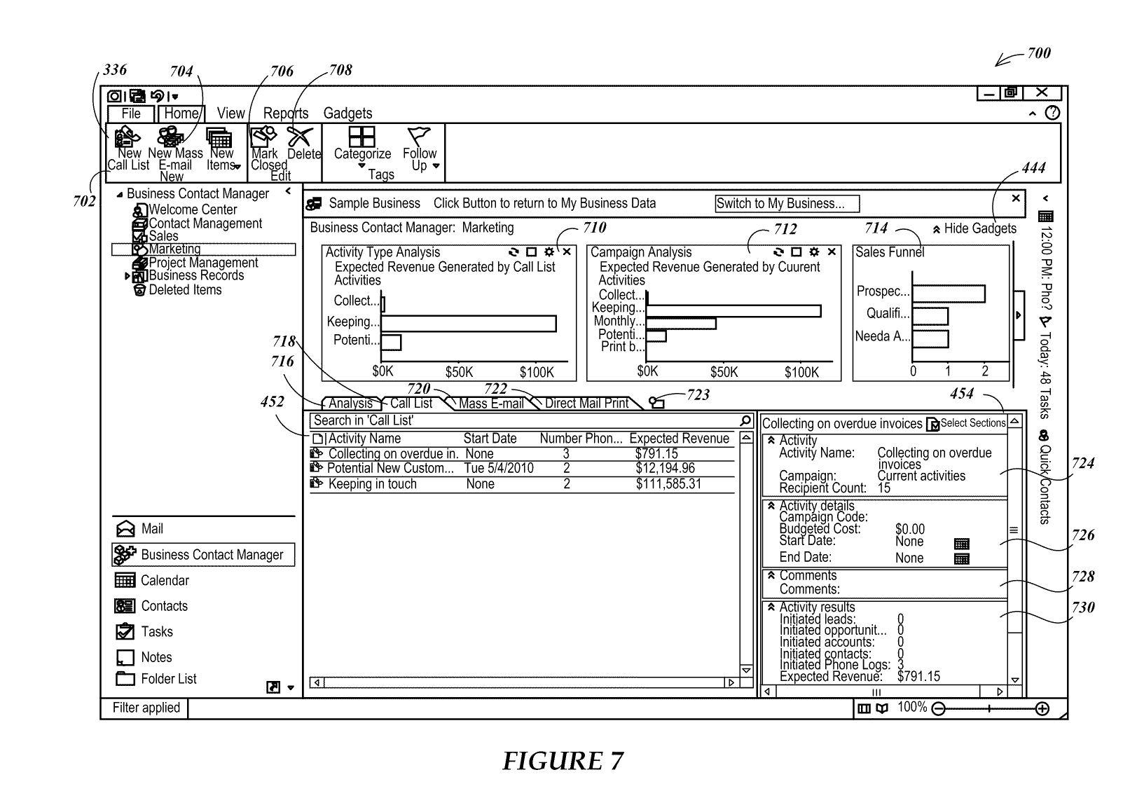

FIG. 7 depicts aspects of an exemplary marketing-related workspace 700. For example, the marketing-related workspace 700 can be provided upon selecting the Marketing component 314 or ribbon option. As described above, interactive ribbon tools and/or gadgets can be dynamically updated to include marketing-related tools and/or gadgets. As shown, the ribbon 336 has been dynamically updated to include marketing-related ribbon tools. For this example, the new section has been updated with a new call list interface 702, and a new mass email interface 704. The ribbon 336 of the exemplary marketing-related workspace 700 has also been dynamically modified to include an edit section that includes a mark closed interface 706, and a delete interface 708. The ribbon 336 of the workspace interface 300 can be modified and dynamically updated to include different types of role-specific tabs within the ribbon display area.

The gadget display section 444 has also been dynamically updated to include marketing-related gadgets. Exemplary marketing-related gadgets can include Activity Type Analysis, Campaign Analysis, Campaign Comparison, Survey Analysis, and Survey Comparison. For this example, the gadget display section 444 has been dynamically updated with an Activity Type Analysis gadget 710, and a Campaign Analysis gadget 712. A Sales Funnel gadget 714 is also displayed to illustrate the capability of the workspace interface 300 to include different types of gadgets within the gadget display section 444. The marketing-related workspace 700 can be used as a focal point for creating and tracking marketing activities, such as marketing campaigns and metric analysis as examples. Accordingly, the marketing-related workspace 700 can be used to provide guidance to users as part of managing a marketing business role.

In one embodiment, the marketing-related workspace 700 can be configured to include marketing-related tabs for each marketing activity. For example, marketing-related tabs can be used to populate the record list display area 452 with information related to mass mail events, follow up events, advertising words success, call lists, direct mail print activities, deal of the week metrics, tracking, and/or other marketing analytics. The marketing-related workspace 700 includes example tabs that include an analysis tab 716, a call lists tab 718, a mass email tab 720, a direct mail print tab 722, and an add new tab 723.

The call lists tab 718 has been selected and the record list display area 452 has been updated with information associated with the user's marketing-related call information for various activities. As discussed above, the record list display area 452 and/or preview pane 454 can be modified by the user to include select information, organized according to a user preference. As shown in FIG. 7, the user has configured the preview pane 454 to include an activity section 724, an activity detail section 726, a comments section 728, and an activity results section 730.

In one embodiment, the marketing-related workspace 700 can be configured to group activities based on content, geography, time, etc. to provide a comparison of return on investment (ROI) parameters between campaigns, including providing budgeting parameters, lead and opportunity parameters, generated revenue parameters, and/or other parameters. Marketing parameters also can include product quality and branding metrics; consumer persuasion and market communication metrics; price perception and impact metrics; and distribution channels and modes of shopping metrics.

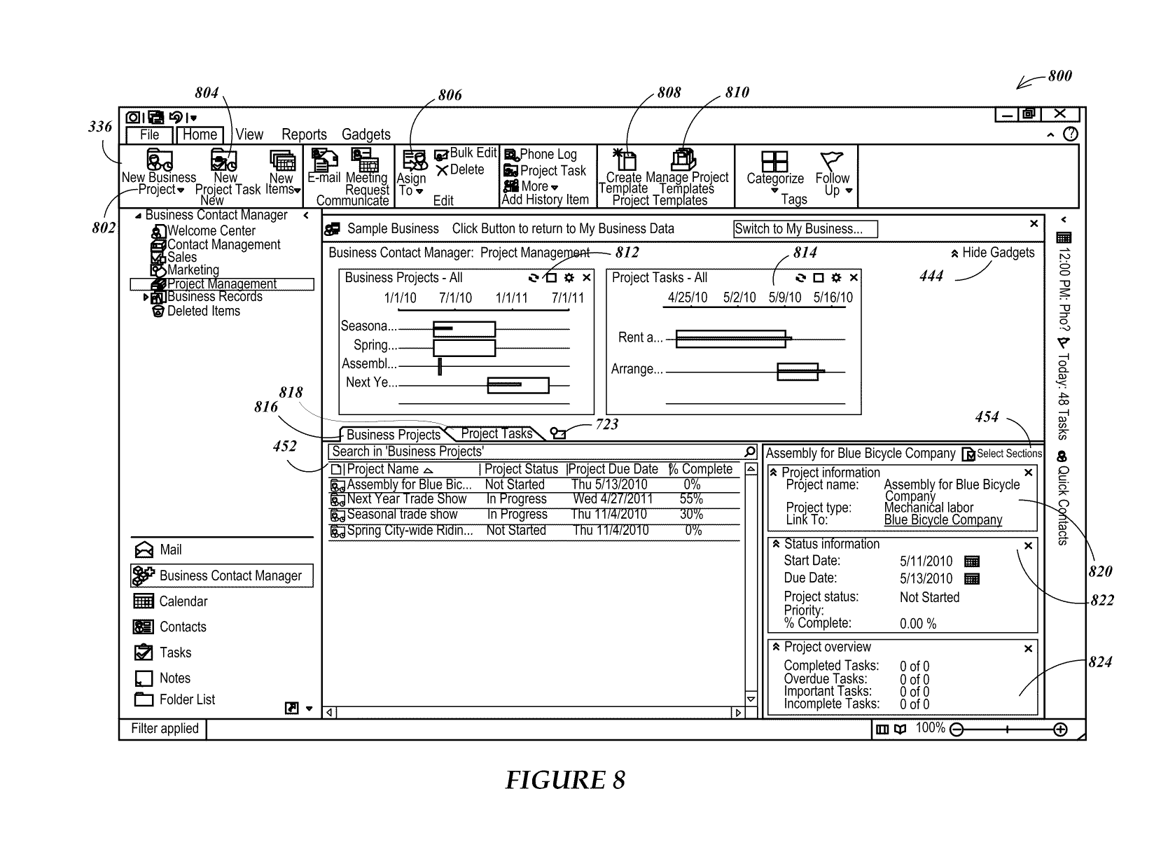

FIG. 8 depicts aspects of an exemplary project-related workspace 800. For example, the project-related workspace 800 can be provided upon selecting the Projects component 316 or ribbon option. As described above, interactive ribbon tools and/or gadgets can be dynamically updated to include project-related tools and/or gadgets. As shown, the ribbon 336 has been dynamically updated to include project-related ribbon tools. For this example, the new section has been updated with a new business project interface 802, and a new project task interface 804. The ribbon 336 of the exemplary project-related workspace 800 has also been dynamically modified to include an assign to interface 806 in the edit section, along with a project templates section that includes a create template interface 808 and a manage projects template interface 810.

The gadget display section 444 has also been dynamically updated to include project-related gadgets. Exemplary project-related gadgets can include Business Projects—Overdue, Business Projects—Due Next, Business Projects—All, Project Tasks—Overdue, Project Tasks—Due Next, and Project Tasks—All. For this example, the gadget display section 444 has been dynamically updated with a Business Projects—All gadget 812 and a Project Tasks—All gadget 814. As discussed above, the workspace interface 300 includes functionality to include different types of role-specific gadgets within the gadget display section 444.

In one embodiment, the project-related workspace 800 can be configured to include project-related tabs for each project activity. The project-related workspace 800 includes example tabs that include a business projects tab 816 and a project tasks tab 818. The business projects tab 816 has been selected and the record list display area 452 has been updated with information associated with user projects for various activities. As discussed above, the record list display area 452 and/or preview pane 454 can be modified by the user to include select information, organized according to a user preference. As shown in FIG. 8, the user has configured the preview pane 454 to include a project information section 820, a status information section 822, and a project overview section 824.

The project-related workspace 800 can be used to provide guidance to users as part of managing a project business role. For example, the project-related workspace 800 can be used as part of effectively managing projects associated with revenue generating resources. An exemplary project-related workspace 800 can be used to view availability, assign, re-assign, modify and/or track assets as part of effectively scheduling, tracking, and/or delegating of work items through various projects, such as revenue and non-revenue generating projects as examples. Project-related parameters can include start date, due date, status, project type, priority, etc.

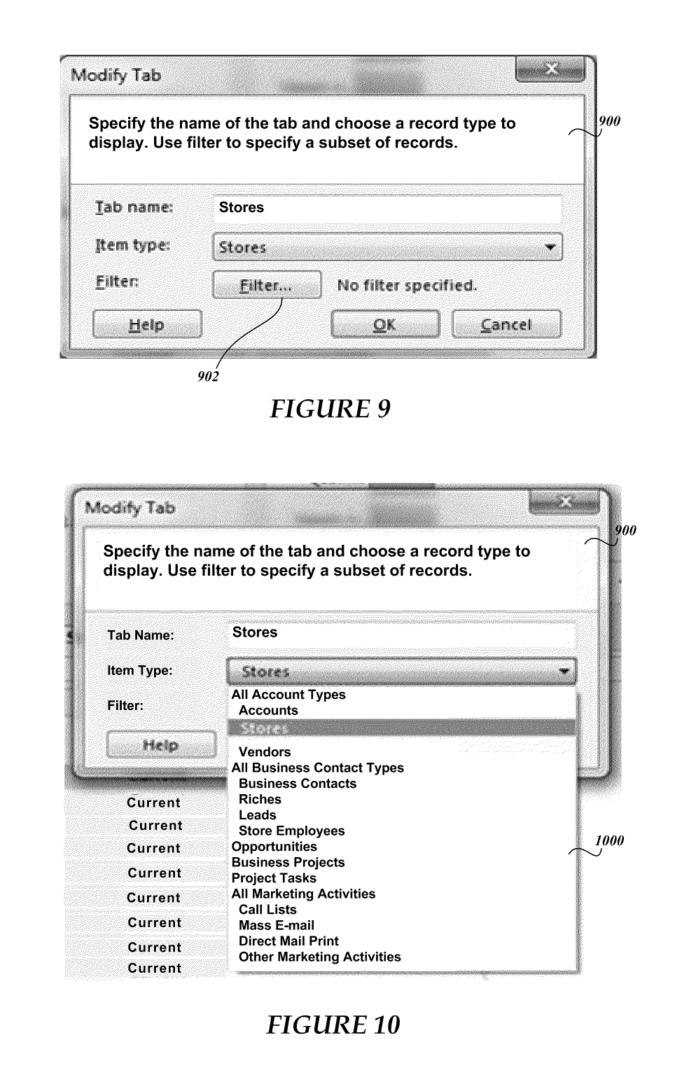

FIG. 9 depicts an exemplary interface 900 that can be used to modify a tab, such as tab 450 for example. As an example, a user can select the type of record to be shown in a tab by right clicking the tab and selecting “Modify” to launch the interface 900. Using interface 900, for each tab, a user can define: the type of the record to be shown; filters to apply; a field grouping; and/or all fields to present in the record list display area 452. The filter interface 902 can be used to limit records to some subset (e.g., only Opportunities assigned to the user, only Stores in Washington state, etc.). The Item type interface 904 can be used to designate a type of record to show in the record list display area 452.

FIG. 10 depicts the exemplary interface 900 provided once the user selects the Item type interface 904. The drop down 1000 shows a number of exemplary available types, allowing the user to select the type of record that a tab will display.

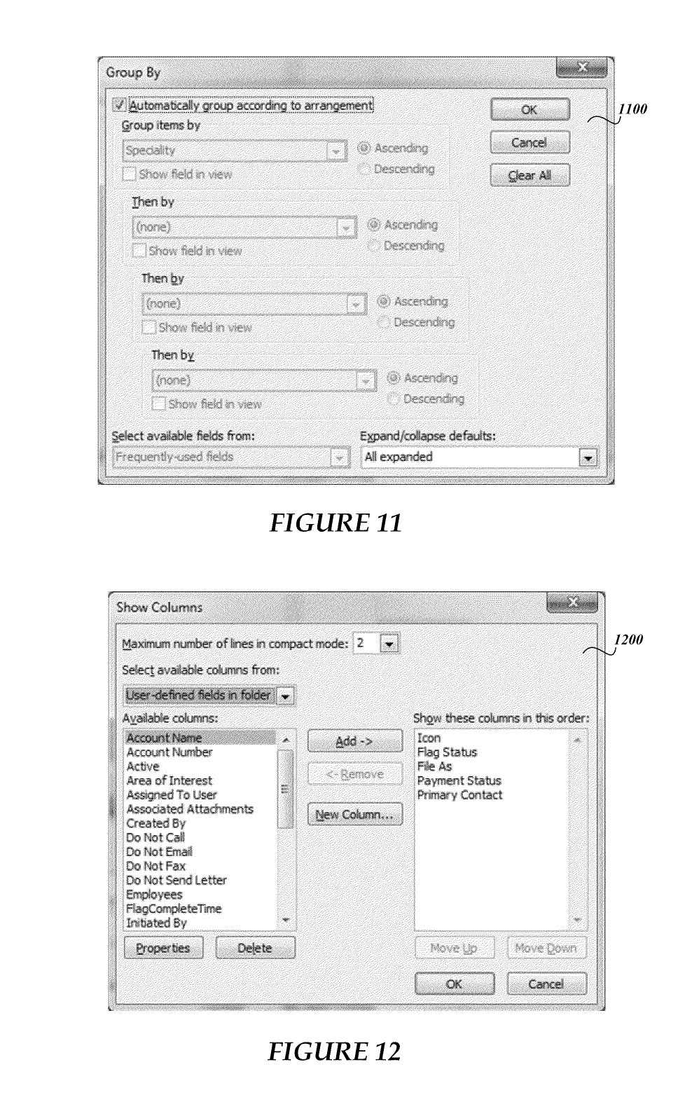

FIG. 11 depicts an exemplary interface 1100 that can be used to group fields. For example, exemplary interface 1100 can be provided using the View interface of the ribbon 336, then selecting “View Settings”, “Group By” to display what is shown in FIG. 11.

FIG. 12 depicts an exemplary interface 1200 that can be used to add a column to the record list display area 452. For example, exemplary interface 1200 can be provided when a user chooses fields from the ribbon 336, or by right-clicking the column header and selecting “Add Columns.”

While aspects of an exemplary workspace interface 300 and application are described above, the workspace interface 300 can include other features and/or functionalities to provide flexibility in terms of user personalization according to each role-specific workspace for any business owner. Additionally, the workspace interface 300 includes functionality that enables creation of other business roles and/or role-specific workspaces. For example, a user can use a web-based client to create a legal workspace that includes legal-related ribbon tools, gadgets, and tabs. As another example, a user can create a financial workspace that includes finance-related ribbon tools, gadgets, and tabs.

In some embodiments, the workspace interface 300 can be a web driven application and/or locally controlled. In one embodiment, workspace interface 300 can be populated with aspects of each role-specific workspace to provide a spectrum of role metrics to an end-user. For example, a user may include a contract chart to show signed and unsigned contracts along with marketing and sales metrics that can be used to identify contractual impacts and contacts to pursue to expedite some task. The workspace interface 300 is customizable and an end-user can personalize each workspace according to some business need or goal, but is not so limited.

A number of examples exemplify certain uses of a workspace interface 300. As one example, a user can use the workspace interface 300 to ignore everything that does not contribute to achieving certain revenue goals. After checking email, the user clicks on the Sales button in the ribbon 336. The user can remove all workspace gadgets to concentrate completely on moving leads and opportunities through the pipeline. As another example of using the workspace interface 300, a small business owner may regularly use sales features, marketing features, and financial features to track ongoing business activities with arranged gadgets for each role-specific workspace. As part of the daily routine, the owner can select the sales component 312, and look at a “Pipeline” tab to see deals in process, allowing for quick click-throughs to scan any details to get a sense of where each opportunity is in the process.

Continuing with another example, the record list display area 452 can be used to track leads that become business building opportunities. Opportunities can be grouped by sales stages customized into a plurality of sales stages that best fit a reading and work style. The sales stages can be sorted by score as part of moving opportunities down the pipeline as effectively as possible. As yet another example, the preview pane 454 can be customized to track a financial business goal by adding custom fields to the preview pane 454 to track financial balances, credit score, and equity. Each custom field can be organized in the preview pane 454, such as locating the custom fields under each contact's name and address, including adding checkboxes for some sales process. As another example of managing day to day business operations using the workspace interface 300, a user can click on a senders email address to add the sender as a business contact as part of a sales opportunity. Other examples and embodiments are available.

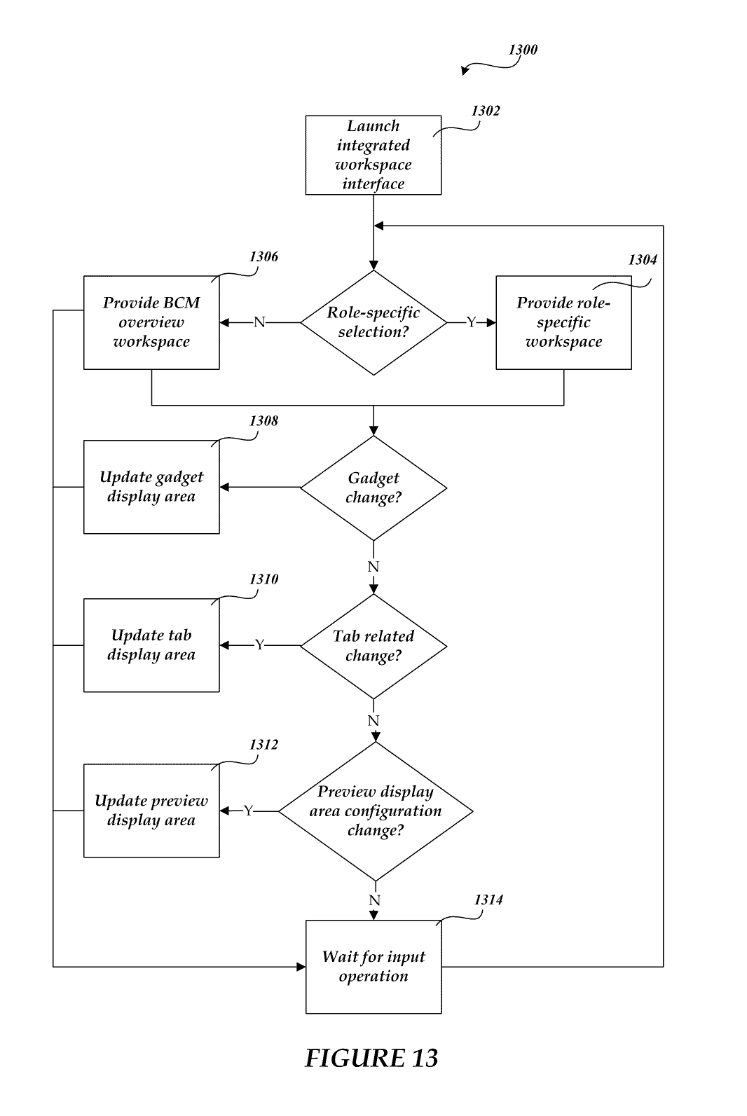

FIG. 13 is a flow diagram illustrating an exemplary process 1300 that can be used to provide an integrated workspace interface supporting a number of role-specific workspaces, each including customizable gadgets, tabs, lists, previews, and ribbon tools, but is not so limited. While a certain number and order of operations is described for the exemplary flow of FIG. 13, it will be appreciated that other numbers and/or orders can be used according to desired implementations.

At 1302, the process 1300 of an embodiment operates to launch an integrated workspace interface. In one embodiment, application code, including executable instructions, operates to launch the integrated workspace interface when a user opens or uses a feature of a personal information management application (e.g., email, calendar, personal contacts, etc.), such as the OUTLOOK personal information management application for example. At 1304, the process 1300 operates to provide and display a role-specific workspace when a user selects a role-specific business function. For example, an integrated workspace interface can be configured to include customizable sales-related features, customizable marketing-related features, customizable project-related features, customizable business contact features, and/or other features, including custom tab displays, custom gadget displays, and/or custom ribbon tool displays.

At 1306, if the user does not select a role-specific workspace, the process 1300 provides an integrated workspace interface that includes business contact management overview information. At 1308, the process 1300 operates to update a gadget display area of a workspace if the user has made any gadget changes. For example, the process 1300 can refresh the gadget display area when a user creates a new gadget, deletes a gadget, and/or modifies a gadget view. In one embodiment, a gadget manager can operate to provide a gadget gallery that displays available gadgets grouped according to a type or function, such as downloaded gadgets, sales gadgets, marketing gadgets, project gadgets, and/or contact gadgets. At 1310, the process 1300 operates to update a tab display area and/or record display area of a workspace if the user has made any tab-related and/or record list changes. At 1312, the process 1300 operates to update a preview display area of a workspace if the user has made any configuration changes to the preview display area. At 1314, the process 1300 waits for further input. While a number of examples are described, other embodiments and examples are available.

Various computing and/or communication devices, systems, and/or environments can be used in conjunction with a multi-role workspace interface application. Components of a computing system can include processing and memory resources, buses, computer readable media, etc. Computer readable and storage mediums can include accessible media and includes volatile and nonvolatile media, and/or removable and non-removable media, implemented in any method or technology for storage of information such as computer readable instructions, data structures, program modules, applications, and/or other data. Communication media includes wired media such as a wired network or direct-wired connection, and wireless media such as acoustic, radio frequency (RF), infrared and other wireless media. An exemplary computing system can include an operating system, application programs, other program modules, and/or program data. A computing system can include a personal computer, a hand-held device, a server, and/or other computing devices/systems configured as part of some networked communication network. In a networked environment, program modules, or certain module portions, can be stored in and/or executed from remote systems/devices.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, RF, infrared, and/or other wired and/or wireless media and components. In addition to computing systems, devices, etc., various embodiments can be implemented as a computing process (e.g., a method), an article of manufacture, such as a computer program product or computer readable media, computer readable storage medium, and/or as part of various communication architectures.

System memory, removable storage, and non-removable storage are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems can be any type and/or combination of processor-based devices or systems. For example, a mobile communication device can be used to interact with a role-specific workspace interface application, including touch and pen based interaction paradigms. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

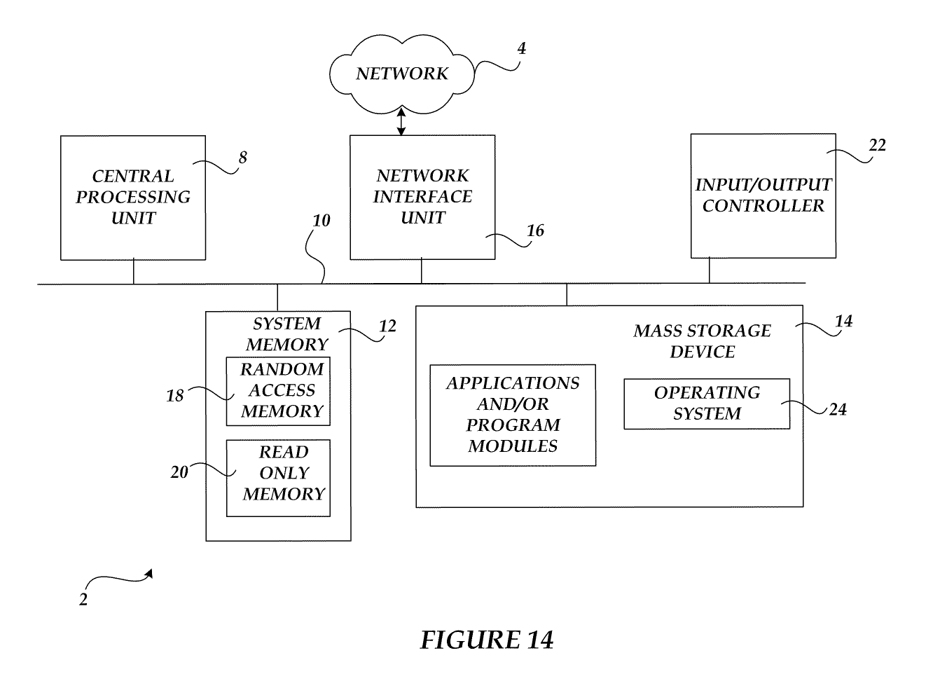

Referring now to FIG. 14, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 14, an illustrative operating environment for embodiments of the invention will be described. As shown in FIG. 14, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
providing aspects of a workspace interface including:
providing a tool ribbon section including workspace tools;
providing a number of selectable role options including:
a first role option associated with a first role-specific workspace that includes first role-specific tabs, first role-specific key performance indicators, and first role-specific record lists;
a second role option associated with a second role-specific workspace that includes second role-specific tabs, second role-specific key performance indicators, and second role-specific record lists; and
a third role option associated with a third role-specific workspace that includes third role-specific tabs, third role-specific key performance indicators, and third role-specific record lists;
providing a configurable preview pane to display list items and other information for each role option; and
displaying the workspace interface.

2. The method of claim 1, further comprising creating a new role option associated with a new personalized role for the workspace interface.

3. The method of claim 2, further comprising defining one or more new role tabs, new role key performance indicators, and new role record lists for the new role option.

4. The method of claim 1, further comprising modifying one or more of the role-specific tabs, gadgets, and record lists of a role-specific workspace.

5. The method of claim 1, further comprising updating the configurable preview pane according to a preview configuration change.

6. The method of claim 5, further comprising updating one or more of a section of the configurable preview pane, a role-specific gadget, and a role-specific tab.

7. The method of claim 1, further comprising defining role options for a sales role workspace, a marketing role workspace, and a project manager role workspace, each role workspace including a customizable interface presentation.

8. The method of claim 1, further comprising integrating email and time management information with the workspace interface.

9. The method of claim 1, further comprising creating tab parameters, list items, and configuring filters to display select role details for a particular role workspace.

10. The method of claim 9, further comprising providing:
sales role details including lead details, forecast details, opportunity details, and sales history details;
marketing role details including marketing campaign details, branding details, and distribution channel details; and
project management details including project details, project task details, and team calendar details.

11. The method of claim 1, further comprising providing role-specific ribbon commands for each role-specific workspace.

12. A computer-implemented user interface comprising:
a tools portion including specific ribbon tools for a number of role-specific workspaces;
a role selection portion including a number of selectable role workspaces including:
a sales role workspace including sales-related tabs, gadgets, and record lists;
a marketing role workspace including marketing-related tabs, gadgets, and record lists; and
a project role workspace including project-related tabs, gadgets, and record lists; and
a role workspace portion to display workspace details associated with each selected workspace including a customizable preview portion to display record list information.

13. The interface of claim 12, further comprising a contact management workspace including contact related tabs and contact related records.

14. The user interface of claim 12, the sales role workspace including sales leads, forecasts, and opportunities.

15. The user interface of claim 12, the marketing role workspace including campaign metrics.

16. The user interface of claim 12, the personalized project management role workspace including ongoing projects and tasks.

17. A computer readable medium including encoded instructions that operate to provide a workspace interface comprising:
integrating a number of personalized workspaces and information management features that include:
a sales workspace that includes sales-related ribbon tools and gadgets;
a marketing workspace that includes marketing-related ribbon tools and gadgets; and,
a project workspace that includes project-related ribbon tools and gadgets;
using one or more of the number of personalized workspaces to manage aspects of an ongoing business;
modifying customizable aspects of the workspace interface; and
displaying the workspace interface to correspond with any modified aspects.

18. The computer readable storage medium of claim 17 including encoded instructions that operate to provide the workspace interface further comprising selecting a role-specific workspace and creating a new tab that includes a number of role-specific records for the role-specific workspace.

19. The computer readable storage medium of claim 17 including encoded instructions that operate to provide the workspace interface further comprising creating a new workspace to correspond to a new business function.

20. The computer readable storage medium of claim 17 including encoded instructions that operate to provide the workspace interface further comprising one or more of adding, creating, and removing role-specific gadgets and tabs for one or more of the personalized workspaces.
